(19) United States
(12) Patent Application Publication
(10) Pub. No.: US 2026/0103367 A1
(43) Pub. Date: Apr. 16, 2026

(54) ROBOT AND OPERATION METHOD THEREOF

(71) Applicant: SAMSUNG ELECTRONICS CO., LTD., Suwon-si (KR)

(72) Inventors: Seungbeom HAN, Suwon-si (KR); Woojeong Kim, Suwon-si (KR); Chanho Yoon, Suwon-si (KR); Eunsoll Chang, Suwon-si (KR)

(73) Assignee: SAMSUNG ELECTRONICS CO., LTD., Suwon-si (KR)

(21) Appl. No.: 19/379,166

(22) Filed: Nov. 4, 2025

Related U.S. Application Data
(63) Continuation of application No. PCT/KR2025/014795, filed on Sep. 22, 2025.

(30) Foreign Application Priority Data
Oct. 10, 2024 (KR) 10-2024-0137820

(51) Int. Cl. B66F 9/06; B65G 1/137; G05D 1/246; G05D 1/617; G05D 105/28

(52) U.S. Cl. CPC B66F 9/063; B65G 1/1373; G05D 1/246; G05D 1/617; G05D 2105/28

(57) ABSTRACT

A robot capable of traveling and transporting cargo includes at least one processor; and memory storing instructions, that, when executed by the at least one processor, individually or collectively, cause the robot to obtain map information relating to a traveling space of the robot; identify, from the map information, at least one region of interest corresponding to a passage, with a first width of the passage being greater than a second width of the robot and a first height of the passage being less than a second height of the robot; obtain, based on the map information, space information corresponding to the at least one region of interest; obtain footprint information corresponding to the robot, and identify a traveling path of the robot based on at least one of the map information and the footprint information; and control the robot to travel based on the traveling path.

### CROSS-REFERENCE TO RELATED APPLICATION(S)

This application is a continuation of International Application No. PCT/KR2025/014795, filed on Sep. 22, 2025, in the Korean Intellectual Property Receiving Office, which claims priority to Korean Patent Application No. 10-2024-0137820, filed on Oct. 10, 2024, in the Korean Intellectual Property Office, the disclosures of which are incorporated by reference herein in their entireties.

### BACKGROUND

### 1. Field

This disclosure relates to a robot and an operation method thereof, and particularly, to a robot traveling a space and an operation method thereof.

### 2. Description of Related Art

With the advancement of electronic technologies, various types of electronic devices have been developed and provided, and in recent years, research has been actively performed into technologies in association with a robot providing services to the user and the like. A robot traveling a specific space to provide services to the user may detect an object present on a traveling path accurately such that the robot may travel on the traveling path efficiently.

### SUMMARY

According to an aspect of the disclosure, a robot capable of traveling and transporting cargo includes at least one processor; and memory storing instructions, wherein the instructions, when executed by the at least one processor, individually or collectively, cause the robot to obtain map information relating to a traveling space of the robot; identify, from the map information, at least one region of interest corresponding to a passage, with a first width of the passage being greater than a second width of the robot and a first height of the passage being less than a second height of the robot; obtain, based on the map information, space information corresponding to the at least one region of interest; obtain footprint information corresponding to the robot, and identify a traveling path of the robot based on at least one of the map information and the footprint information; and control the robot to travel based on the traveling path.

According to an aspect of the disclosure, an operation method of a robot capable of traveling and transporting cargo, the method includes obtaining map information relating to a traveling space of the robot; identifying, from the map information, at least one region of interest corresponding to a passage with a first width of the passage being greater than a second width of the robot and a first height of the passage being less than a second height of the robot; obtaining, based on the map information, space information corresponding to the at least one region of interest; obtaining footprint information corresponding to the robot, and identifying a traveling path of the robot based on at least one of the map information and the footprint information; and controlling the robot to travel based on the traveling path.

According to an aspect of the disclosure, a non-transitory computer readable storage medium storing instructions thereon, that, when executed by at least one processor of a robot capable of traveling and transporting cargo, causes the robot to obtain map information relating to a traveling space of the robot; identify, from the map information, at least one region of interest corresponding to a passage with a first width being greater than a second width of the robot and with a first height of the passage being less than a second height of the robot; obtain, based on the map information, space information corresponding to the at least one region of interest; obtain footprint information corresponding to the robot, and identify a traveling path of the robot based on at least one of the map information and the footprint information; and control the robot to travel based on the traveling path.

### BRIEF DESCRIPTION OF THE DRAWINGS

FIG. 1 is a schematic view provided to explain an operation method of a robot according to one embodiment;

FG. 2 is a block diagram of a configuration of a robot according to one embodiment;

FIG. 3 is a flowchart provided to explain an operation method of a robot according to one embodiment;

FIG. 4 is a flowchart provided to explain a method of obtaining footprint information according to one embodiment;

FIG. 5 is a flowchart provided to explain a method of identifying a traveling path according to one embodiment;

FIG. 6 is a flowchart provided to explain a method of identifying a traversable region according to one embodiment;

FIG. 7A, FIG. 7B, and FIG. 7C are views provided to explain a method of identifying a region of interest according to one embodiment;

FIG. 8 is a view provided to explain map information corresponding to a traveling space according to one embodiment; and

FIG. 9 is a block diagram of a configuration of a robot according to one embodiment.

### DETAILED DESCRIPTION

Hereafter, the subject matter of the present disclosure is described specifically with reference to the accompanying drawings.

The terms used herein are described briefly, and the subject matter of the disclosure is described specifically.

General terms currently widely used are selected as the terms used in the embodiments of the disclosure in consideration of their functions in the disclosure, but may be changed based on the intention of those skilled in the art or a judicial precedent, the emergence of a new technology, or the like. In addition, in a specific case, terms arbitrarily chosen by the applicant may be included in the terms used herein. In this case, the meanings of such terms are described in detail in the description of the disclosure. Therefore, the terms used in the disclosure need to be defined based on the meanings thereof and overall details throughout the disclosure rather than simply the names thereof.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, it is to be understood that the expression at least one of A or/and B denotes any one of “A”or “B”or “A and B”.

In the disclosure, the expression “1st”, “2nd”, “first”, or “second”, and the like may be used to refer to various types of elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

Singular forms include plural forms as well, unless explicitly indicated otherwise. In the disclosure, it is to be understood that the term “include” or “comprised of” and the like mean the presence of stated features, numbers, steps, operations, elements, components or combinations thereof but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. Additionally, a plurality of “modules” or a plurality of “units” may be integrated into at least one module and be implemented as at least one processor, apart from a “module” or a “unit”that needs to be implemented by specific hardware.

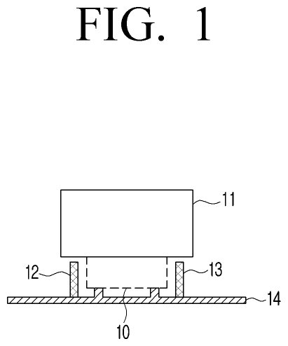

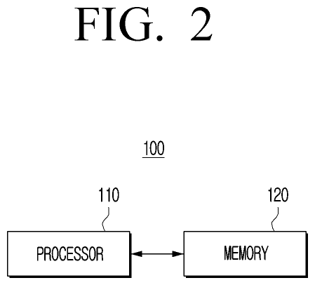

FIG. 1 is a schematic view provided to explain an operation method of a robot according to one embodiment.

Referring to FIG. 1, a robot 10 may load a cargo 11, according to one embodiment. In one example, the robot 10 in the state of loading a cargo 11 may identify a region of interest in a traveling space such that the robot 10 may travel the traveling space. In one example, the robot 10 may obtain map information relating to a traveling space of the robot and may identify, from the map information, at least one region of interest corresponding to a passage 12 and 13 having a first width greater than a second width of the robot 10 and a first height less than a second height of the robot 10, in the traveling space. In one example, the first height of the passage and the second height may be a height measured with respect to a ground surface 14.

In one example, based on identifying the region of interest in the traveling space, the robot 10 may identify map information corresponding to the traveling space, which includes space information corresponding to the at least one region of interest. In one example, the space information corresponding to the region of interest may be 3-dimentional (3D) type map information with respect to the at least one region of interest or 2-dimensional (2D) type map information including a plurality of layers with respect to the at least one region of interest.

In one example, the robot 10 may identify a region that is traversable by the robot 10 out of the region of interest, considering a state in which a cargo 11 is loaded. In one example, the robot 10 may identify a traveling path of the robot 10 based on footprint information corresponding to the robot 10 that includes the cargo 11 and based on the map information on the traveling space. In one example, the footprint information corresponding to the robot 10 may be information on a space that is occupied by the robot 10 and the cargo 11. In one example, the robot 10 may identify a region in which the robot 10 is capable of passing through the passage 12 and 13 in the traveling space based on the footprint information, and identify the traveling path based on the identified region.

In one example, the robot 10 may be controlled to travel based on the traveling path.

FIG. 2 is a block diagram of a configuration of a robot according to one embodiment.

Referring to FIG. 2, a robot 100 may be implemented as a robot 100 that is capable of traveling a traveling space, according to one embodiment. In one example, the robot 100 may include at least one processor 110 and memory 120.

In one example, the robot 100 may reach a destination by traveling the traveling space. The robot 100 may be a robot that moves to a position and provides services to the user. In one example, the robot may be a different type of traveling robot including a drone robot or a wheel robot, but not limited thereto.

According to one embodiment, the robot may also be implemented as an autonomous mobile robot (AMR) or a forklift mobile robot (FMR). In one example, the AMR may be a robot that identifies a path autonomously and travels a space without traveling on a preset path. In one example, the FMR may be a forklift-type robot that autonomously identifies a traveling path in a traveling space and travels based on the identified traveling path.

The at least one processor 110 (hereafter, a processor) is electrically connected to the memory 120 and control entire operations of the robot 100. The processor 110 may be comprised of one processor or a plurality of processors. The processor 110 may perform operations of the robot 100 according to various embodiments of the disclosure by executing at least one instruction stored in the memory 120.

In one example, the processor 110 may be implemented as a digital signal processor (DSP) processing a digital image signal, a microprocessor, a graphics processing unit (GPU), an artificial intelligence (AI) processor, a neural processing unit (NPU), or a time controller (TCON). However, the processor 110 may not be limited thereto, and the processor 110 may include one or more of a central processing unit (CPU), a micro controller unit (MCU), a micro processing unit (MPU), a controller, an application processor (AP), or a communication processor (CP), an ARM processor, or may be defined as a corresponding term. Additionally, the processor 110 may be implemented as a system on a chip (SoC) with embedded processing algorithms or a large scale integration (LSI), or an application specific integrated circuit (ASIC), or a field Programmable gate array (FPGA).

The memory 120 may store data for various embodiments. The memory 120 may be implemented in the form of memory embedded in the robot 100, or in the form of memory detachable from the robot 100 depending on a data storage purpose. For example, in the case of data for driving of the robot 100, the data may be stored in the memory embedded in the robot 100, and in the case of data for an expansion function of the robot 100, the data may be stored in memory detachable from the robot 100.

Meanwhile, the memory embedded in the robot 100 may be implemented as at least one of volatile memory (e.g., dynamic RAM (DRAM), static RAM (SRAM) or synchronous dynamic RAM (SDRAM), and the like), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard travel, or solid-state travel (SSD)). Additionally, the memory detachable from the robot 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

According to one embodiment, the processor may identify a region of interest in a traveling space in which a robot travels. In one example, the processor may obtain map information relating to a traveling space of the robot and may identify, from the map information, at least one region of interest corresponding to a passage having a first width greater than a second width of the robot and a first height less than a second height of the robot, out of the traveling space. In one example, the passage may be a passage that is traversable by the robot. In one example, the processor may identify the region where the width of the passage is greater than the width of the robot and where the first height of the passage is less than the second height, in the traveling space. In one example, the processor may obtain map information relating to a traveling space of the robot and may identify, from the map information, a region of interest that is within a preset distance from the region where the width of the passage is greater than the width of the robot and where the first height is less than the second height. In one example, the first height may denote a maximum value of a distance (or a perpendicular distance) between the passage and the ground surface. In one example, the second height may denote a maximum value of a distance (or a perpendicular distance) between the robot and the ground surface. In one example, a third height of a cargo may denote a height of a bottom portion (or a portion closest from the ground surface) of the cargo from the ground surface.

The robot may include at least one sensor from among a camera, a LiDAR sensor, or an infrared sensor, and the space information may be obtained based on sensing data collected from the at least one sensor.

In one example, the processor may identify a region that satisfies the above-described conditions, in the traveling space, based on sensing data obtained through at least one sensor and information on the robot. In one example, the processor may obtain information on each of a first width and a first height of at least one passage included in the traveling space, based on the sensing data. In one example, the information on the robot may include information on a shape of the robot (e.g., information on a height and width of a robot).

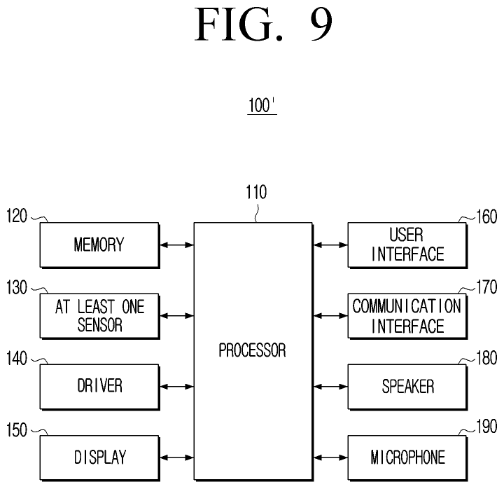

In one example, the at least one sensor, as a sensor capable of obtaining 3-dimentional (3D) information corresponding to the traveling space, may be at least one of a camera sensor, a LiDAR sensor or an infrared sensor, for example, but not limited thereto. In one example, the processor may obtain sensing data from an external device (e.g., a server). In the case where the robot includes at least one sensor (e.g., at least one sensor 130 of FIG. 9), the processor may also obtain sensing data from the at least one sensor.

In one example, the processor may obtain information on each of a first width and a first height of at least one passage included in the traveling space. In one example, the processor may obtain information on a region of interest from the external device.

According to one embodiment, the processor may obtain, based on the map information, space information corresponding to at least one region of interest.

In one example, based on identifying the region of interest in the traveling space, the processor may identify space information corresponding to the at least one region of interest. In one example, the space information corresponding to the region of interest may be 3D-type map information with respect to the at least one region of interest or 2D-type map information including a plurality of layers with respect to the at least one region of interest. In one example, the 2D-type map information including a plurality of layers may be map information including a plurality of maps in which heights from the ground surface differ with respect to an identical region.

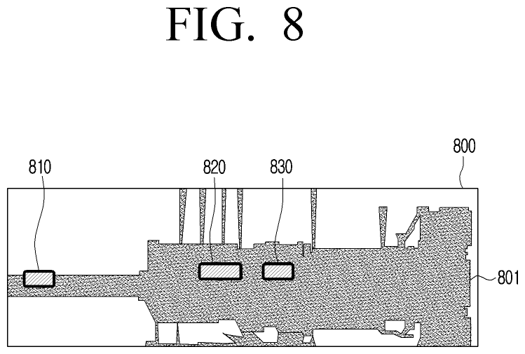

In one example, based on identifying the space information corresponding to the at least one region of interest, the processor may obtain map information including the space information as map information corresponding to the traveling space. In one example, the map information corresponding to the traveling space may include at least one of information on a shape of the traveling space, information on a passage in the traveling space, and information on a position and size of an object present in the traveling space. The space information and the map information corresponding to the traveling space are described with reference to FIG. 8.

In one example, the processor may obtain map information corresponding to the traveling space from an external device (e.g., a server), but not limited thereto, and in one example, the map information corresponding to the traveling space may also be stored in memory.

According to one embodiment, the processor may identify a traveling path of the robot. In one example, based on obtaining footprint information corresponding to the robot including a cargo, the processor may identify a traveling path of the robot based on at least one of the map information corresponding to the traveling space and the footprint information corresponding to the robot.

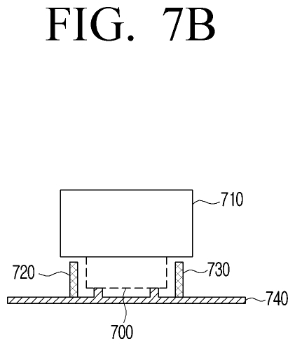

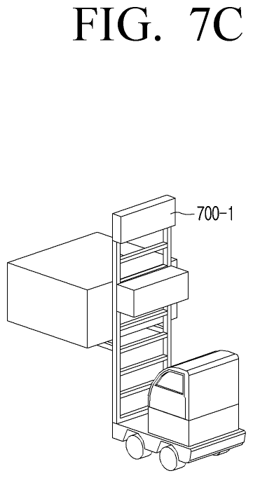

In one example, the robot may load a different type of cargo. In one example, the robot, as illustrated in FIG. 1, may load a cargo at an upper end thereof. In one example, a robot, as illustrated in FIG. 7C, may also load a cargo at a preset position.

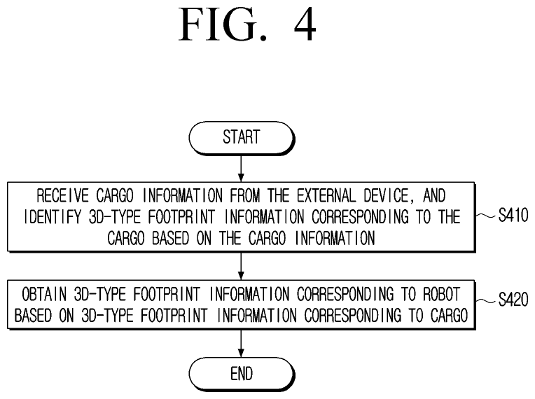

In one example, the processor may obtain footprint information corresponding to the robot including a cargo. In one example, the footprint information corresponding to the robot may be information indicating a space occupied by the robot and the cargo. For example, the footprint information corresponding to the robot may be 3D-type information corresponding to the robot including the cargo. The footprint information corresponding to the robot, for example, may be 2D-type information. A method of obtaining footprint information corresponding to the robot is described with reference to FIG. 4.

In one example, the processor may obtain 3D-type footprint information corresponding to the robot from an external device. In one example, a robot may include a communication interface (e.g., a communication interface 170 of FIG. 9). In one example, the processor may obtain, from an external device (e.g., a server) via the communication interface, 3D-type footprint information corresponding to the robot. In one example, in the case where an external device is provided with a system (e.g., a camera sensor and the like) capable of measuring an exterior (e.g., a width or height and the like) of the robot including the cargo, the external device may obtain 3D-type footprint information corresponding to the robot including the cargo. The external device may transmit the obtained footprint information to the robot such that the robot obtains 3D-type footprint information.

In one example, the processor may also obtain footprint information corresponding to the robot, based on cargo information. For example, the cargo information may include information on a position at which the cargo is loaded in the robot, a size of the cargo, and a third height of the cargo. In one example, the third height may be a height of a bottom portion (or a portion closest from the ground surface) of the cargo from the ground surface. In one example, the processor may obtain 3D-type footprint information corresponding to the robot based on the cargo information, even in the case where the processor may not obtain the 3D-type footprint information corresponding to the robot from an external device. Related descriptions are provided with reference to FIG. 4.

In one example, the processor may also determine 2D-type footprint information corresponding to the robot based on a preset maximum cargo size. For example, the processor may also determine footprint information corresponding to the robot, based on the preset maximum cargo size, in the case where the processor does not obtain the 3D-type footprint information corresponding to the robot from the external device and also does not obtain the cargo information. Related descriptions are provided with reference to FIG. 4.

In one example, the processor may identify a traveling path of the robot based on at least one of the map information corresponding to the traveling space and the footprint information corresponding to the robot. In one example, based on obtaining the footprint information corresponding to the robot, the processor may identify a space (or a region) that is traversable by the robot, based on the obtained footprint information and the map information corresponding to the traveling space. In one example, the processor may identify the region that is traversable by the robot based on the footprint information corresponding to the robot, out of the region of interest.

For example, it may be assumed that there is a first region where a passage has a width that is greater than a width of the robot and less than a width of the cargo, out of the region of interest. The processor may identify the first region as a region that is traversable by the robot, based on the footprint information and the map information, despite the width of the passage less than the width of the cargo, in the case where a first height of the passage is less than a second height of the robot.

According to one embodiment, the processor may control the robot such that the robot may be controlled to travel based on the identified traveling path. In one example, the robot may further include a driver (e.g., a driver 140 of FIG. 9). In one example, the processor may control the driver such that the robot may travels on the identified traveling path.

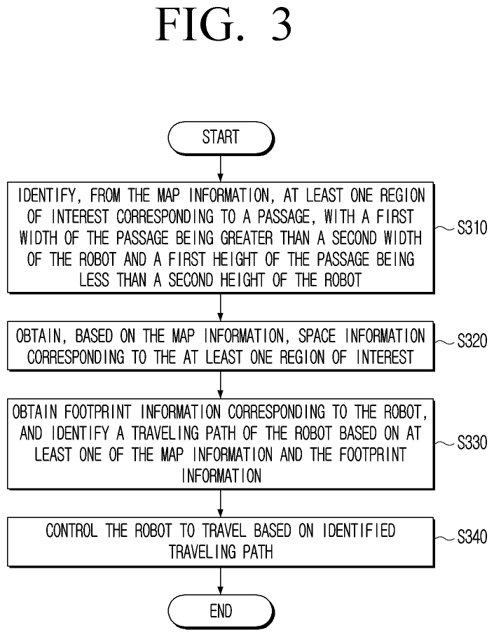

FIG. 3 is a flowchart provided to explain an operation method of a robot according to one embodiment.

Referring to FIG. 3, the operation method may include obtaining map information relating to a traveling space of the robot, and identifying, from the map information, at least one region of interest corresponding to a passage with a first width being greater than a second width of a robot and with a first height of the passage being less than a second height of the robot, according to one embodiment (S310).

In one example, a robot (e.g., a robot 100 of FIG. 2) may identify at least one region of interest corresponding to a passage (e.g., a passage of FIG. 2) with a first width being greater than a second width of the robot and a first height of the passage being less than a second height of the robot. In one example, the processor may obtain map information relating to a traveling space of the robot and may identify, from the map information as a region of interest (e.g., a region of interest of FIG. 2), a region present within a preset distance from the region in which the passage has a first width greater than the second width and has a first height less than the second height.

According to one embodiment, the operation method may include obtaining, based on the map information (e.g., map information on a traveling space of FIG. 2), space information (e.g., space information of FIG. 2) corresponding to the at least one region of interest (S320).

In one example, the robot may identify the space information corresponding to the region of interest. In one example, the space information corresponding to the region of interest may be 3D-type map information with respect to the at least one region of interest or 2D-type map information including a plurality of layers with respect to the at least one region of interest. In one example, the map information corresponding to the traveling space may include 3D-type map information or 2D-type information including a plurality of layers with respect to the at least one region of interest, and may include 2D-type map information with respect to a region apart from the at least one region of interest.

According to one embodiment, based on obtaining footprint information (e.g., footprint information of FIG. 2) corresponding to the robot including a cargo, the operation method may include identifying a traveling path of the robot based on at least one of the map information corresponding to the traveling space and the footprint information corresponding to the robot (S330).

In one example, the robot may obtain the footprint information corresponding to the robot. In one example, the robot may load a cargo. In one example, the robot may obtain, from an external device (e.g., a server) via a communication interface (e.g., a communication interface 170 of FIG. 9), 3D-type footprint information corresponding to the robot including a cargo. In one example, based on obtaining the footprint information, the robot may identify a region that is traversable by the robot based on the obtained footprint information and the map information corresponding to the traveling space. In one example, the robot may identify a traveling path based on the traversable region.

According to one embodiment, the operation method may include traveling based on the identified traveling path (S340).

In one example, based on identifying the traveling path, the robot may travel the traveling space based on the identified traveling path. For example, the robot may control a driver 140 (e.g., a driver 140 of FIG. 9) such that the robot may be controlled to travel based on the traveling path.

In the above-described example, the robot may identify a path that is traversable by using the footprint information and may travel on the identified path, even in the case where the robot includes a cargo. Accordingly, the robot may travel efficiently since the robot identifies, as a traversable region, even a region that is identified as a non-traversable region based on 2D-type map information.

Further, in the above-described example, the robot may identify a traveling path by using map information including 3D-type information only with respect to the region of interest in the traveling space. Accordingly, a storage amount of memory may decrease, and a data computing amount of the robot for identifying the traveling space may decrease since a 3D-type map is not generated with respect to all the regions in the traveling space.

FIG. 4 is a flowchart provided to explain a method of obtaining footprint information (e.g., footprint information of FIG. 2) according to one embodiment.

Referring to FIG. 4, the operation method may include receiving cargo information from an external device (e.g., a server) via the communication interface, and identifying 3D-type footprint information (e.g., footprint information of FIG. 2) corresponding to the cargo based on the received cargo information, according to one embodiment (S410).

In one example, the cargo information may include a position at which the cargo is loaded in a robot (e.g., a robot 100 of FIG. 2), a size of the cargo and a third height of the cargo. In one example, the third height may denote a height of a bottom portion of the cargo from the ground surface.

In one example, based on receiving no 3D-type footprint information corresponding to the robot (e.g., 3D-type footprint information corresponding to a robot of FIG. 2) from an external device, the robot may receive cargo information from the external device via a communication interface 170 (e.g., a communication interface 170 of FIG. 9),. In one example, the cargo information may be stored in memory (e.g., memory 120 of FIG. 2), and the robot may obtain the cargo information based on information stored in the memory.

In one example, based on the cargo information, the robot may obtain 3D-type footprint information corresponding to the cargo. In one example, the robot may obtain the 3D-type footprint information corresponding to the cargo, by using a preset algorithm.

According to one embodiment, the operation method may include obtaining 3D-type footprint information corresponding to the robot based on the 3D-type footprint information corresponding to the cargo (S420).

In one example, the robot may obtain 3D-type footprint information corresponding to the robot excluding a cargo. In one example, the 3D-type footprint information corresponding to the robot excluding a cargo may be footprint information of the robot in a default state. In one example, the 3D-type footprint information corresponding to the robot excluding a cargo may be stored in the memory, but not limited thereto, and in one example, the robot may also obtain the 3D-type footprint information corresponding to the robot excluding a cargo from an external device (e.g., a server).

In one example, the robot may obtain 3D-type footprint information corresponding to the robot by combining the 3D-type footprint information corresponding to the cargo and the 3D-type footprint information corresponding to the robot excluding a cargo.

In one example, based on receiving no cargo information from an external device, the robot may also determine footprint information corresponding to the robot based on a preset maximum cargo size. In one example, the preset maximum cargo size may be 2D-type information. For example, the preset maximum cargo size may be a maximum size occupiable by the cargo on a 2D map. In on example, the robot may determine the footprint information corresponding to the robot based on the preset maximum cargo size. In this case, the footprint information corresponding to the robot may be 2D-type information.

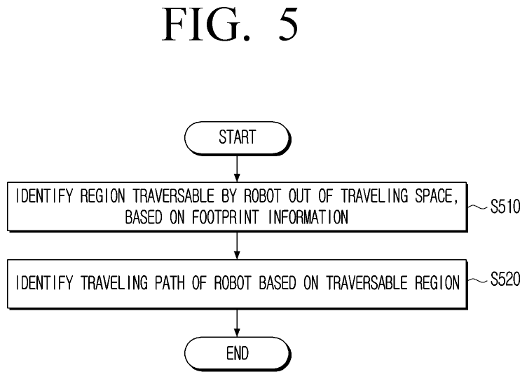

FIG. 5 is a flowchart provided to explain a method of identifying a traveling path (e.g., a traveling path of FIG. 2) according to one embodiment.

Referring to FIG. 5, the operation method may include identifying a region that is traversable (e.g., a robot 100 of FIG. 2), out of a traveling space, based on footprint information (e.g., footprint information of FIG. 2), according to one embodiment (S510).

In one example, based on obtaining footprint information corresponding to the robot, the robot may identify a space (or a region) that is traversable based on the obtained footprint information and map information corresponding to the traveling space (e.g., map information on a traveling space of FIG. 2). In one example, the robot may identify a region that is traversable by the robot based on the footprint information corresponding to the robot, out of the region of interest (e.g., a region of interest of FIG. 2).

For example, it may be assumed that there is a first region in which a passage (e.g., a passage of FIG. 2) has a width greater than a width of the robot and less than a width of the cargo, out of the region of interest. The robot may identify, as a region that is traversable, the first region, despite the width of the passage less than the width of the cargo, in the case where a first height of the passage is less than a second height of the robot based on the footprint information and map information.

It may be assumed that a third height of the cargo is less than a second height of the robot, for example. The robot may determine whether the robot is capable of passing through the passage by comparing the third height with the first height of the passage, and based on this, may determine whether the robot is capable of traveling. Even in the case where the cargo is loaded at a relatively low position in the robot, the robot may determine that the robot is capable of passing through the passage based on the third height being greater than the first height. Based on this, the robot may identify a region that is traversable out of the region of interest.

According to one embodiment, the operation method may include identifying a traveling path of a robot based on a traversable region (S520). In one example, the robot may identify a region that is traversable out of the at least one region of interest. In one example, the robot may identify a traveling path considering the identified traversable region.

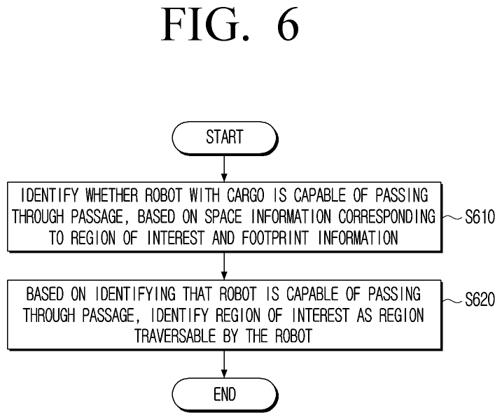

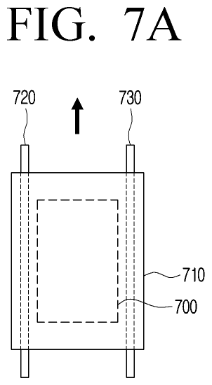

FIG. 6 is a flowchart provided to explain a method of identifying a traversable region (e.g., a traversable region of FIG. 5) according to one embodiment.

Referring to FIG. 6, the operation method may include identifying whether a robot (e.g., a robot 100 of FIG. 2) including a cargo is capable of passing through a passage (e.g., a passage of FIG. 2) included in a region of interest, based on space information (e.g., space information of FIG. 2) corresponding to the region of interest (e.g., a region of interest of FIG. 2) and footprint information (e.g., footprint information of FIG. 2), according to one embodiment (S610).

In one example, the space information may be 3D-type map information with respect to at least one region of interest or 2D-type map information including a plurality of layers with respect to at least one region of interest. In one example, the robot may identify information indicating a space occupied by the robot and the cargo, based on footprint information corresponding to the robot including the cargo. In one example, the robot may identify whether the robot, with the cargo, is capable of passing through the passage included in the at least one region of interest.

For example, the robot may identify whether a third height of the cargo is greater than a first height of the passage included in the region of interest, based on the information indicating the space occupied by the robot and the cargo. In one example, the third height may be a height of a bottom portion of the cargo from the ground surface. The robot may identify that the robot is capable of passing through the passage in the case where the third height is greater than the first height of the passage.

In one example, as is the case with an FMR (e.g., an FMR of FIG. 2) to which a cargo is loaded, the robot may identify that the robot is capable of passing through the passage, based on identifying that the third height of the cargo is greater than the first height of the passage, in the case where the third height is less than a second height of the robot.

According to one embodiment, the operation method may include identifying the region of interest as a region that is traversable, based on identifying that the robot is capable of passing through the passage (S620).

In one example, based on identifying that the robot is capable of passing through the passage included in the region of interest, the robot may identify the region of interest as a region that is traversable. In one example, the robot may identify a traveling path such that the robot may travel to the traversable region. In one example, the robot may control a driver (e.g., a driver 140 of FIG. 9) such that the robot may travel on the identified path.

FIG. 7A, FIG. 7B, and FIG. 7C are views provided to explain a method of identifying a region of interest (e.g., a region of interest of FIG. 2) according to one embodiment.

Referring to FIG. 7A, FIG. 7B, and FIG. 7C, a robot 700 (e.g., a robot 100 of FIG. 2) may load a cargo 710, according to one embodiment. In one example, the cargo 710 may be loaded at a relatively upper side of the robot 700 as illustrated in FIG. 7A and FIG. 7B, but not limited thereto, and in one example, in the case where the robot 700 is implemented as an FMR 700-1, the cargo 710, as illustrated in FIG. 7C, may also be loaded in a preset region of the robot 700 (e.g., a front portion of a robot).

In one example, in the case of a robot 700 illustrated in FIG. 7A and FIG. 7B, a third height of the cargo 710 (e.g., a height of a cargo of FIG. 2) may be a value greater than or equal to a second height of the robot 700 (e.g., a height of a robot of FIG. 2). In one example, in the case of a robot 700 illustrated in FIG. 7C, a third height of the cargo 710 may be less than a second height of the robot 700. In one example, a first height of a passage 720 and 730 may denote a maximum value of a distance (or a perpendicular distance) between the passage 720 and the passage 730 and a ground surface 740. In one example, the second height 700 may denote a maximum value of a distance (or a perpendicular distance) between the robot 700 and the ground surface 740. In one example, the third height 710 may denote a height of a bottom portion (or a portion closest from the ground surface 740) of the cargo 710 from the ground surface 740.

In one example, the robot 700 may identify a passage 720 and 730 with a first width greater than a second width of the robot 700 and with a first height less than the second height of the robot 700. In one example, the robot 700 may identify a region that satisfies the above-described conditions in the traveling space, based on sensing data obtained through at least one sensor and robot information 700. In one example, the robot 700 may obtain information on the first width and the first height of at least one passage (each of 720 and 730) included in the traveling space, based on the sensing data. In one example, the robot information 700 may include information on a shape of the robot 700 (e.g., a height and a width of a robot 700).

In one example, in the case where an external device (e.g., a server) includes at least one sensor, the robot 700 may obtain sensing data from the external device. In one example, the robot 700 may include at least one sensor, and obtain sensing data from the at least one sensor. The robot 700 may obtain information on a region of interest from the external device. In one example, the robot information 700 may be stored in memory (e.g., memory 120 of FIG. 2), but not limited thereto, and the robot 700 may obtain the robot information 700 from the external device.

In one example, based on identifying the passage 720 and 730, the robot 700 may identify a region of interest within a preset distance from the identified passage 720 and 730.

In one example, the robot 700 may identify a traversable region (e.g., a traversable region of FIG. 2), out of the region of interest. For example, the robot 700 may identify, as a traversable region, a region passable by the robot 700, with the cargo 710, based on space information (e.g., space information of FIG. 2) corresponding to the region of interest and footprint information corresponding to the robot 700 (e.g., footprint information corresponding to a robot 700 of FIG. 2).

In one example, the robot 700 may identify a region that is traversable out of the region of interest by comparing the third height of the cargo 710 and the first height of the passage 720 and 730. For example, the robot 700 may compare the third height 710 and the Firt height of the passage 720 and 720 based on the space information corresponding to the region of interest and the footprint information corresponding to the robot 700. Based on identifying that the third height 710 is greater than the first height 720 and 730, the robot 700 may identify the region of interest including the passage 720 and 730 as a traversable region.

In the above-described example, the robot 700 may efficiently identify the region that is traversable based on the information on the region of interest (e.g., space information corresponding to a region of interest), even in the case where a width of the cargo 710 is greater than the width of the passage 720 and 730, and based on this, identify a traveling path.

FIG. 8 is a view provided to explain map information on a traveling space (e.g., map information on a traveling space of FIG. 2) according to one embodiment.

Referring to FIG. 8, the map information 800 on a traveling space 801 may include at least one of information on a shape of the traveling space 801, information on a passage in the traveling space 801, and information on a position and a size of an object present in the traveling space 801, according to one embodiment.

In one example, the map information 800 corresponding to the traveling space 801 may include space information corresponding to a region of interest 810, 820 and 830 (e.g., a region of interest of FIG. 2). In one example, the space information (e.g., space information of FIG. 2) corresponding to the region of interest 810, 820 and 830 may be 3D-type map information 800 with respect to at least one region of interest 810, 820 and 830 or 2D-type map information 800 including a plurality of layers with respect to at least one region of interest 810, 820 and 830. In one example, the 2D-type map information 800 including a plurality of layers may be map information 800 including a plurality of maps in which heights from the ground surface differ with respect to an identical region.

In one example, the map information 800 corresponding to the traveling space 801 may include 3D-type map information 800 or 2D-type map information including a plurality of layers, with respect to the at least one region of interest 810, 820 and 830, and may include 2D-type map information with respect to a region apart from the at least one region of interest 810, 820 and 830. For example, the map information 800 corresponding to the traveling space 801 may include 3D-type space information corresponding to the region of interest 810, 820 and 830, and 2D-type map information 800 corresponding to a region apart from the region of interest 810, 820 and 830.

In the above-described example, the map information 800 corresponding to the traveling space 801 may include 3D-type map information 800 or 2D-type map information 800 including a plurality of layers with respect to the region of interest 810, 820 and 830, and include 2D-type map information 800 with respect to a region apart from the region of interest 810, 820 and 830, and accordingly, a data size of the map information 800 may be less than that of map information comprised only of 3D-type map information 800. Accordingly, a data computing amount for identifying a traveling path (e.g., a traveling path of FIG. 2) may decrease such that the robot (e.g., a robot 100 of FIG. 2) may identify the traveling path efficiently.

FIG. 9 is a block diagram of a configuration of a robot according to one embodiment.

Referring to FIG. 9, a robot 100′ may include at least one processor 110, memory 120, at least one sensor 130, a driver 140, a display 150, a user interface 160, a communication interface 170, a speaker 180 and a microphone 190. Among elements illustrated in FIG. 9, detailed description of the elements illustrated in FIG. 2 is avoided.

The at least one sensor 130 may include a plurality of sensors of various types. The at least one sensor 130 may measure a physical quantity or sense an operation state of the robot 100′, and convert the measured or sensed information into an electrical signal. The at least one sensor 130 may include a camera, and the camera may include a lens focusing visible light reflected and received from an object and other optical signals on an image sensor and an image sensor sensing visible light and other optical signals. Herein, the image sensor may include a 2D pixel array differentiating into a plurality of pixels. The at least one sensor 130 may also include a temperature sensor or an infrared sensor. In one example, the at least one sensor 130 may include at least one of a 2-dimensional (2D) LiDAR sensor or a 3-dimensional (3D) LiDAR sensor. The at least one sensor 130 may also include an obstacle detection sensor that senses an obstacle by using 3D-type information.

The driver 140 is a device enabling the robot 100′ to travel. The driver 140 may adjust a traveling direction and a traveling speed under the control of the processor 110, and in one example, the driver 140 may include a power generating device (e.g., a gasoline engine, a diesel engine, a liquefied petroleum gas (LPG) engine, an electric motor and the like based on used fuel (or a source of energy)) generating power for the robot 100′ to travel, a steering device for adjusting a traveling direction (e.g., a manual steering device, a hydraulics steering device, an electronic control power steering (EPS) device and the like), a traveling device (e.g., wheels, a propeller and the like based on power) enabling the robot 100′ to travel, and the like. Herein, the driver 140 may be modified based on a traveling type (e.g., a wheel type, a walking type, a flying type and the like) of the robot 100′.

The display 150 may be implemented as a display including a self-emissive element or a display including a non-self-emissive element and a backlight. For example, the display 150 may be implemented as various types of displays such as a liquid crystal display (LCD), an organic light emitting diode (OLED) display, a light emitting diode (LED) display, a micro LED display, a mini LED display, a plasma display panel (PDP), a quantum dot (QD) display, a quantum dot light-emitting diode (QLED) display and the like. In the display 150, driving circuitry implementable in the form of an a-si thin film transistor (TFT), a low temperature poly silicon (LTPS) TFT, an organic TFT (OTFT) and the like, a backlight unit, and the like may be included together. Meanwhile, the display 150 may be implemented as a touch screen coupled with a touch sensor, a flexible display, a rollable display, a three-dimensional (3D) display, a display in which a plurality of display modules are connected physically, and the like. The processor 110 may control the display 150 to output an input image that is obtained according to the above-described embodiments. Herein, the output image may be an image of high resolution that is 4K, 8K or greater than or equal to 8K. In one example, the output image may be a game image.

According to one embodiment, the display 150 may include a plurality of haptic elements. The haptic elements may be implemented as a motor for providing a haptic feedback (e.g., a vibration feedback) to the user, but not limited thereto. In one example, the display 150 may include a preset number of haptic elements. For example, the display 150 may include a preset number of haptic elements corresponding to a preset number of sub areas of the display, but not be limited thereto, and the number of haptic elements included in the display 150 may differ from the number of a plurality of sub areas corresponding to the display.

The user interface 160 is an element for the robot 100′ to perform an interaction with the user. For example, the user interface 160 may include at least one of a touch sensor, a motion sensor, a button, a jog dial, a switch, a microphone or a speaker, but not be limited thereto.

The communication interface 170 may input and output various types of data. For example, the communication interface 170 may transceive various types of data with an external device (e.g., a source device), an external storage medium (e.g., USB memory), or an external server (e.g., webhard), based on a communication method such as AP-based Wi-Fi (Wi-Fi, Wireless LAN network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial and the like.

In one example, the communication interface 170 may include a Bluetooth Low Energy (BLE) module. The BLE denotes a Bluetooth technology enabling transmission and reception of low-power low-capacity data in a 2.4-GHz frequency band having a reach radius of about 10 m. However, the communication interface 170 may not be limited thereto, and may also include a Wi-Fi communication module. That is, the communication interface 170 may include at least one of a Bluetooth Low Energy (BLE) module or a Wi-Fi communication module.

According to one embodiment, the speaker 180 may be comprised of a tweeter for replaying a sound in a high vocal range, a midrange for replaying a sound in an intermediate vocal range, a woofer for replaying a sound in a low vocal range, a subwoofer for replaying a sound in an extremely low vocal range, an enclosure for controlling resonance, a crossover network dividing an electrical signal frequency input to the speaker based on each band, and the like.

According to one embodiment, the speaker 180 may output an acoustic signal to the outside of the robot 100'. The speaker 180 may output a multimedia replay, a recording replay, various notification sounds, a voice message and the like. The robot 100′ may include an audio output device such as a speaker 180, but may also include an input device such as an audio output terminal. In particular, the speaker 180 may provide obtained information, information processed/generated based on the obtained information, a response result to a user voice or an operation result and the like, in the form of a voice.

The microphone 190 may denote a module obtaining a sound and converting the sound into an electrical signal, and may be a condenser microphone, a ribbon microphone, a moving coil microphone, a piezoelectric microphone, a carbon microphone, or a micro electro mechanical system (MEMS) microphone. Additionally, the microphone 190 may be implemented based on an omnidirectional method, a bidirectional method, a uni-directional method, a sub cardioid method, a super cardioid method, or a hyper cardioid method. According to one embodiment, the robot 100′ may include the microphone 190 and an inner microphone, and the microphone 190 may be a microphone disposed at a relatively outward side of the body. In one example, the robot 100′ may obtain an audio signal including an external noise through the microphone 190. According to one embodiment, the microphone 190 may be disposed in a direction opposite to a direction in which the speaker 180 emits a sound.

According to the above-described embodiments, even in the case where the robot 100′ of the present disclosure includes a cargo, the robot 100′ may identify a path that is traversable by using footprint information, and travel on the identified path. Accordingly, the robot 100′ may identify, as a traversable region, even a region that is identified as a non-traversable region based on 2D-type map information, such that the robot may travel efficiently.

Additionally, according to the above-described embodiments, the robot 100′ may identify a traveling path by using map information including 3D-type information only with respect to a region of interest, in a traveling space. Accordingly, since a 3D-type map is not generated with respect to all regions in the traveling space, a storage amount of the memory 120 may decrease, and a data computing amount of the robot for identifying the traveling space may decrease.

Meanwhile, the methods, according to the embodiments described above, may be implemented in the form of an application that is installable in an existing robot. The methods, according to the embodiments described above, may be performed by using a trained neural network based on deep learning (or a deep neural network), i.e., a trained network model. Additionally, the methods, according to the embodiments described above, may be implemented only based on an upgrade of software of an existing robot or an upgrade of hardware. Additionally, the embodiments set forth herein may be performed through an embedded server provided in a robot or an external server of a robot.

The embodiments described above may be implemented with software including instructions stored in a storage medium readable by a machine (e.g., a computer). The machine, as a device capable of calling the stored instructions from the storage media and operating according to the called instructions, may include a display device (e.g., display device A) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” means that the storage medium does not include a signal and only means that the storage medium is tangible, while the term does differentiate semi-permanent or temporary storage of data in the storage medium.

According to the embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store^{TM}). In the case of online distribution, at least a portion of the computer program product may be stored at least temporarily, or provided temporarily in a storage medium such as a manufacturer's server, a server of an application store, or memory of a relay server.

Further, each of the elements (e.g., a module or a program) according to the embodiments described above may be comprised of a single entity or a plurality of entities, and other sub elements may be further included in the embodiments. Alternatively or additionally, some of the elements (e.g., modules or programs) may be integrated into one entity to perform identical or similar functions performed by each corresponding element prior to integration. Operations performed by a module, a program, or another element, according to the embodiments, may be executed sequentially, in parallel, repetitively, or heuristically, or at least some of the operations may be executed in a different order, or may add a different operation.

While example embodiments of the present disclosure are illustrated and described above, embodiments of the disclosure are not limited to specific embodiments set forth herein, and certainly, various modifications thereof may be made by those skilled in the art to which the present disclosure pertains, without departing from the scope the disclosure, claimed in the section of claims, and should not be understood as separating from the technical spirit or prospect of the disclosure.

What is claimed is:

1. A robot capable of traveling and transporting cargo, the robot comprising:
at least one processor; and
memory storing instructions,
wherein the instructions, when executed by the at least one processor, individually or collectively, cause the robot to:
obtain map information relating to a traveling space of the robot;
identify, from the map information, at least one region of interest corresponding to a passage, with a first width of the passage being greater than a second width of the robot and a first height of the passage being less than a second height of the robot;
obtain, based on the map information, space information corresponding to the at least one region of interest;
obtain footprint information corresponding to the robot, and identify a traveling path of the robot based on at least one of the map information and the footprint information; and
control the robot to travel based on the traveling path.

2. The robot as claimed in claim 1, wherein the space information comprises at least one of:
3-dimensional (3D) type map information comprising a plurality of layers with respect to the at least one region of interest, or
2-dimensional (2D) type map information comprising a plurality of layers with respect to the at least one region of interest, and wherein the map information further comprises 2D-type map information corresponding to a region apart from the at least one region of interest.

3. The robot as claimed in claim 1, wherein the robot further comprises a communication interface, and
wherein the instructions, when executed by the at least one processor, individually or collectively, cause the robot to obtain, from an external device via the communication interface, 3D-type footprint information corresponding to the robot.

4. The robot as claimed in claim 3, wherein the instructions, when executed by the at least one processor, individually or collectively, cause the robot to:
receive cargo information from the external device via the communication interface;
identify 3D-type footprint information corresponding to the cargo based on the cargo information; and
obtain the 3D-type footprint information corresponding to the robot based on the 3D-type footprint information corresponding to the cargo.

5. The robot as claimed in claim 4, wherein the instructions, when executed by the at least one processor, individually or collectively, cause the robot to based on the cargo information not being received from the external device, determine the footprint information based on a preset maximum cargo size.

6. The robot as claimed in claim 1, wherein the footprint information comprises space information indicating a space occupied by the robot and the cargo, and
wherein the instructions, when executed by the at least one processor, individually or collectively, cause the robot to:
identify a traversable region by the robot out of the traveling space, based on the footprint information; and
identify the traveling path of the robot based on the traversable region.

7. The robot as claimed in claim 6, wherein the instructions, when executed by the at least one processor, individually or collectively, cause the robot to:
identify whether the robot, with the cargo, is capable of passing through the passage, based on the space information corresponding to the region of interest and the footprint information; and
based on identifying that the robot is capable of passing through the passage, identify the at least one region of interest as a region that is traversable.

8. The robot as claimed in claim 7, wherein the instructions, when executed by the at least one processor, individually or collectively, cause the robot to:
identify whether a third height of the cargo is greater than the first height; and
based on the third height being greater than the first height, identify the at least one region of interest to be traversable.

9. The robot as claimed in claim 1, wherein the robot is an autonomous mobile robot (AMR) or a forklift mobile robot (FMR).

10. The robot as claimed in claim 2, wherein the robot further comprises at least one sensor from among a camera, a LiDAR sensor, or an infrared sensor, and
wherein the space information is obtained based on sensing data collected from the at least one sensor.

11. An operation method of a robot capable of traveling and transporting cargo, the method comprising:
obtaining map information relating to a traveling space of the robot;
identifying, from the map information, at least one region of interest corresponding to a passage with a first width of the passage being greater than a second width of the robot and a first height of the passage being less than a second height of the robot;
obtaining, based on the map information, space information corresponding to the at least one region of interest;
obtaining footprint information corresponding to the robot, and identifying a traveling path of the robot based on at least one of the map information and the footprint information; and
controlling the robot to travel based on the traveling path.

12. The method as claimed in claim 11, wherein the space information comprises at least one of:
3-dimensional (3D) type map information comprising a plurality of layers with respect to the at least one region of interest, or
2-dimensional (2D) type map information comprising a plurality of layers with respect to the at least one region of interest, and wherein the map information includes 2D-type map information corresponding to a region apart from the at least one region of interest.

13. The method as claimed in claim 11, further comprising:
obtaining, from an external device via a communication interface of the robot, 3D-type footprint information corresponding to the robot.

14. The method as claimed in claim 13, the method further comprising:
receiving cargo information from the external device via the communication interface; and
identifying 3D-type footprint information corresponding to the cargo based on the cargo information,
wherein the obtaining the 3D-type footprint information comprises obtaining the 3D-type footprint information based on the 3D-type footprint information corresponding to the cargo.

15. The method as claimed in claim 14, the method further comprising:
based on the cargo information not being received from the external device from the external device, determining the footprint information based on a preset maximum cargo size.

16. The method as claimed in claim 11, wherein the footprint information comprises space information indicating a space occupied by the robot and the cargo, and wherein the identifying the traveling path comprises:
identifying a traversable region by the robot out of the traveling space, based on the footprint information; and
identifying the traveling path of the robot based on the traversable region.

17. The method as claimed in claim 16, wherein the identifying the traversable region comprises:
identifying whether the robot, with the cargo, is capable of passing through the passage, based on the space information corresponding to the region of interest and the footprint information; and
based on identifying that the robot is capable of passing through the passage, identifying the at least one region of interest as a region that is traversable.

18. The method as claimed in claim 17, wherein the identifying whether the robot, with the cargo, is capable of passing through the passage comprises:
identifying whether a third height of the cargo is greater than the first height; and
based on the third height being greater than the first height, identifying the at least one region of interest to be traversable.

19. The method as claimed in claim 11, wherein the robot is an autonomous mobile robot (AMR) or a forklift mobile robot (FMR).

20. A non-transitory computer readable storage medium storing instructions thereon, that, when executed by at least one processor of a robot capable of traveling and transporting cargo, causes the robot to:
obtain map information relating to a traveling space of the robot;
identify, from the map information, at least one region of interest corresponding to a passage with a first width being greater than a second width of the robot and with a first height of the passage being less than a second height of the robot;
obtain, based on the map information, space information corresponding to the at least one region of interest;
obtain footprint information corresponding to the robot, and identify a traveling path of the robot based on at least one of the map information and the footprint information; and
control the robot to travel based on the traveling path.
